(19) United States
(12) Patent Application Publication
(10) Pub. No.: US 2013/0111999 A1
(43) Pub. Date: May 9, 2013

(54) METHOD AND DEVICE FOR NON-DESTRUCTIVE MATERIAL TESTING BY MEANS OF ULTRASOUND

(71) Applicants: Gerd Dobmann, Saarbrucken (DE); Gerhard Hübschen, Saarlouis (DE); Jochen Kurz, Saarbrucken (DE)

(72) Inventors: Gerd Dobmann, Saarbrucken (DE); Gerhard Hübschen, Saarlouis (DE); Jochen Kurz, Saarbrucken (DE)

(21) Appl. No.: 13/695,821

(22) PCT Filed: May 4, 2011
(86) PCT No.: PCT/EP11/02227

§ 371 Date: Jan. 15, 2013

(30) Foreign Application Priority Data
May 5, 2010 (DE) 10 2010 019 477.8

(51) Int. Cl. G01N 29/24

(52) U.S. Cl. CPC G01N 29/24
USPC 73/643

(57) ABSTRACT

A method is described for non-destructive material testing on a workpiece comprising an electrically conductive material using EMUS transducers, each of which has a magnet unit for locally introducing a magnetic field into the workpiece, and also has a radio frequency (RF) coil arrangement, which interacts with the magnetic field. The invention is distinguished in that at least two transcuers are spaced apart along a surface of the workpiece. At least a first EMUS transducer generates and also measures ultrasound waves within the workpiece and the second EMUS transducer functions as a reception transducer for at least detecting ultrasound waves.

### CROSS REFERENCE TO RELATED APPLICATIONS

Reference is made to German Patent Application No. DE 10 2010 019 477.8, filed May 5, 2010 and PCT/EP2011/002227, filed May 4, 2011, which applications are incorporated herein by reference in its entirety.

### BACKGROUND OF THE INVENTION

1. Field of the Invention

The invention relates to a method and also a device for non-destructive material testing on a workpiece of an electrically conductive material using EMUS transducers, each of which has a magnet unit for locally introducing a magnetic field into the workpiece, and an RF coil which interacts with the magnetic field.

2. Description of the Prior Art

Electromagnetic ultrasound transducers, (EMUS transducers) used for non-destructive material testing (ZMU) on a workpiece of an electrically conductive material have long been known art. The basic principles concerning the ability to generate ultrasound waves electrodynamically by targeted utilization of Lorentz forces and also magnetostriction, if the material is ferromagnetic, are known. EP 0 440 317 B1, for example, describes a method and a testing device for the testing of ferromagnetic workpieces using ultrasound.

Typical applications of ZMU testing, such as, for example, the measurement of workpiece thicknesses, the testing of workpieces for material flaws, such as for example cavities or cracks, are described in numerous known art. In particular, workpieces that are subjected to high mechanical and thermal loadings must be tested for any fatigue damage occurring as a result of these loadings. For example, austenitic pipelines in power stations, chemical plants and refineries, or plant components directly exposed to the hot gases in gas turbine power stations, such as, for example, turbine blading, are subjected to high mechanical and/or thermomechanical stresses, which for reasons of safety must be inspected for possible microstructure damage or changes caused by the loadings.

In addition to known methods for the testing of the microstructure on workpieces and/or workpiece test pieces resulting from fatigue damage, such as, for example, utilization of the magnetic Barkhausen noise effect, see DE 42 35 387 C1. For the use of the potential probe method which has been known art for several decades, see in this respect DE 38 28 552 C2, or the use of x-ray voltage analyses, measurable dependencies have been established, in particular in the context of ultrasound tests, between ultrasound wave propagation behavior and ageing-related or loading-related microstructural changes within a workpiece.

For example, for a high-temperature resistant steel alloy (P92), evidence has been found from measurements that a linear relationship exists between the back-scatter behavior of ultrasound surface waves coupled into the workpiece test piece (so-called Rayleigh waves) and a level of damage originating from ageing-related creep-fatigue damage. See Yokono, Y. et al, “Non-destructive Evaluation of Creep Damage using Leaky Surface Acoustic Wave Technique”, JMSE International Journal, Series A, Volume 45, No. 1 (2002), Pages 39 to 45.

Although in the development of creep damage within a workpiece other mechanisms are present than in thermal-mechanical material fatigue, the first stage of the creep damage is also characterized by the formation of defined arrangements of dislocations. In this respect it can be assumed that non-destructive testing methods that enable the detection of the first stage of creep damage also have the potential for the early detection of microstructural changes that are caused by fatigue stresses. For the individual phases of the damage, namely a) the formation of dislocations in the microstructure of the workpiece, b) the occurrence of pores, c) the occurrence of oriented pores that interconnect to form micro-cracks, d) the growth of micro-cracks and macro-cracks up to shortly before the fracture of the workpiece in question, on the basis of knowledge previously acquired the following measurable dependencies can be established in conjunction with the onset of early creep damage as follows:

Even at the onset of dislocations formed in the microstructure of the workpiece, that is to say, in the early phase of creep damage, the amplitude of Rayleigh waves propagating along the workpiece surface decreases, especially as more and more energy is consumed by scatter and multiple scatter within the workpiece volume.

Moreover, the propagation velocity of the ultrasound pulses decreases as a result of dissipation, as a result of which there is a segregation of the higher frequency components in the spectrum of the ultrasound wave pulses. For the same reason, namely the dissipative effects, the central frequency of the frequency spectrum of the ultrasound pulse decreases at the same time,

### SUMMARY OF THE INVENTION

The invention is a method and also a device for non-destructive material testing of a workpiece formed of an electrically conductive material, using EMUS transducers having a magnet unit for locally introducing a magnetic field into the workpiece, and also has a radio frequency (RF) coil arrangement that interacts with the magnetic field. The method and device improve reliability and sensitivity to detect microstructural changes, in particular fatigue and creep damage at an early stage. The expenditure required for this purpose, in terms of the technical development of the method and also the device is low and cost-effective.

A method for non-destructive testing of a workpiece in accordance with the invention comprising an electrically conductive material uses at least two EMUS transducers relative to a surface of the workpiece which are spaced apart along the workpiece surface. At least a first EMUS transducer generates and also detects ultrasound waves within the workpiece. A second EMUS transducer, functioning as a reception transducer, at least detects ultrasound waves. The at least two EMUS transducers the following measure signals. Specifically, the first EMUS transducer measures ultrasound echo signals, which emanate from the first EMUS transducer. For this purpose pulse-echo technology is used to detect the transit times and also the amplitudes of ultrasound wave components reflected within the workpiece are measured with the first EMUS transducer. Furthermore ultrasound waves are measured by the second EMUS transducer which are created within the workpiece by the first EMUS transducer and propagate in the form of near-surface Rayleigh waves. In this case also, amplitudes and transit times of the Rayleigh waves impinging on the second EMUS transducer are measured and evaluated using sonic technology. Moreover the transmission current used to activate the RF coil of the first EMUS transducer is also measured. Finally, in a special test cycle, sound emission signals are measured by the second EMUS transducer which originate at any flaws developing within the workpiece, such as, for example micro-cracks. In this test cycle, sound signals are received by the EMUS reception transducer operating in a passive mode. These sound signals emanate from elastic waves that are produced during crack formation and their growth. Transient signals are received by the second EMUS transducer and are correspondingly detected and recorded.

Finally, all the above measured signals, that is the ultrasound wave echo signals as reception voltages are detected by the first EMUS transducer and the sonic signals detected in a time separated manner by the second EMUS transducer, the transmission current of the RF coil of the first EMUS transducer, and also the sound emission signals, are the basis of the non-destructive material testing to provide the early detection of microstructural changes.

In a particularly advantageous manner, the current and voltage of the RF coil of the first EMUS transducer are measured as suitable further measurement parameters.

By utilization of the ultrasound and eddy current measured quantities in accordance with the invention, it is possible to detect sensitive changes within the microstructure of workpiece surfaces reliably, and also in the near-surface regions of the workpiece. The measured signals obtained with the method in accordance with the invention are compared with reference data that have been accumulated within the environment of thermomechanical fatigue tests on corresponding reference workpieces for which the microstructural quality has been determined by conventional methods of testing, such as, for example, strain gauges, x-ray analysis, magnetic methods utilizing Barkhausen noise, to name just a few. In this manner a reference dataset is obtained in which specific microstructural states are assigned to the ultrasound and eddy current measured quantities which makes possible at least a qualitative evaluation of the measured signals measured on a workpiece that is being tested.

A further, particularly preferred variant of the embodiment of the method in accordance with the invention provides for the use of multiple second EMUS transducers in the form of reception transducers. These second EMUS transducers are applied in a distributed manner over an area of the workpiece surface to determine, for example, the location of material flaws, as for example, the location of a developing micro-crack.

For purposes of executing the method in accordance with the invention for non-destructive material testing at least two EMUS transducers are required. These EMUS transducers must be spaced apart on the surface of the workpiece that is to be tested. Of the at least two EMUS transducers, a first EMUS transducer generates and measures the ultrasound waves. The at least one second EMUS transducer serves primarily as a reception transducer for the detection of ultrasound waves. Both EMUS transducers are connected to a control and evaluation unit, which applies a transmission current to the RF coil of the at least first EMUS transducer, and which measures the amplitude of the transmission current and also the voltage of the RF coil of the first EMUS transducer. Within the environment of the control and evaluation unit, the ultrasound echo signals of the first EMUS transducer are evaluated accounting for transit time and reception amplitudes. The ultrasound sonic signals which are received by the second EMUS transducer are integrated within the environment of the control and evaluation unit with respect to their amplitudes, and a measurement of transit time is executed.

The transit time measurement can be undertaken in accordance with the following methods: pulse-echo superposition, tracking of an amplitude null point, or cross-correlation. The accuracy is in each case dependent on the number of individual measurements which are determined.

The device in accordance with the invention comprises at least two EMUS transducers for non-destructive material testing which is preferably designed as a portable, manually operable unit, with which workpieces of any shape and size can be evaluated.

A typical area of application of the invention is the non-destructive material characterization of austenitic pipelines in power stations, chemical plants and refineries, which are subjected to mechanical and/or thermomechanical stresses. In a particularly advantageous manner not only the device in accordance with the invention, but also the above described method, are suitable for the monitoring of components in real time. The method of the invention can be executed at periodic intervals on appropriate test pieces, such as, for example, on the wheels of railway cars. The method in accordance with the invention can basically be performed on all electrically conductive materials which is not necessarily limited to steels, in particular austenitic steels.

### BRIEF DESCRIPTION OF THE DRAWINGS

In what follows the invention is described in an exemplary manner with reference to the drawings, with the aid of examples of embodiment, and without any limitation of the general concept of the invention. Here:

FIGS. 1a, b and c show a schematic representation of a device designed in accordance with the invention in three alternative arrangements on a fatigue test piece; and

FIG. 2 shows a device in accordance with the invention on a pipeline that is to be tested.

### DETAILED DESCRIPTION OF THE INVENTION

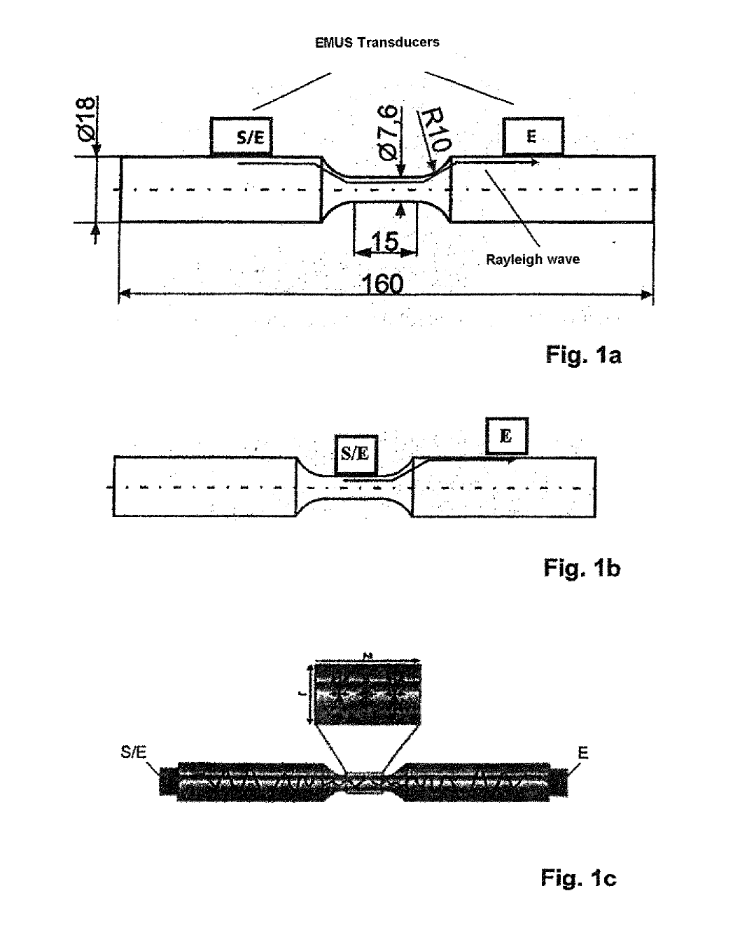

FIGS. 1a and b represent the longitudinal section through a fatigue test piece of an essentially cylindrical design, which has a length of 160 mm and a reduced diameter center section with a length of 15 mm and a reduced diameter of 7.6 mm. The reduced diameter center section widens out at either end along its longitudinal extent via a curvature radius R10, and each end has the end sections bordering the fatigue test piece and each having a diameter of 18 mm.

In the example in accordance with FIG. 1a, the first EMUS transducer S/E is applied to the left-hand fatigue test piece end section. The first EMUS transducer both transmits ultrasound waves into the fatigue test piece and is also able to detect ultrasound wave components reflected within the fatigue test piece. On the right-hand section of the fatigue test piece the second EMUS transducer E is applied. The second EMUS transducer functions as a reception transducer and is able to detect Rayleigh waves transmitted by the first EMUS transducer S/E into the fatigue test piece. Rayleigh waves are able to propagate near the surface longitudinally with respect to the fatigue test piece and travel through the reduced diameter center section (see arrow). In an alternative to placing the first EMUS transducer S/E on the left-hand fatigue test piece section, it is also possible to arrange the first EMUS transducer S/E in the reduced diameter center section of the fatigue test piece itself, as is seen in the embodiment in accordance with FIG. 1b. In both the embodiments of FIGS. 1a and 1b as described, the reception transducer E can also be used to detect sound emission signals that emanate from the elastic waves that are released during the formation and growth of the crack.

A third method and embodiment of arranging the EMUS transducers is shown in FIG. 1c. Here both the first EMUS transducer S/E and the second EMUS transducer E are applied onto opposing end faces of the fatigue test piece. In this arrangement the first EMUS transducer S/E is able to transmit radially polarized ultrasound waves into the fatigue test piece which propagate along the elongated fatigue test piece; in the z-direction, and in the radial direction which generate oriented particle deflections, that is pressure waves (see the detailed representation in FIG. 1c).

With the ultrasound transducer embodiment illustrated in FIGS. 1a, b and c, ultrasound waves can be received and evaluated using pulse-echo technology and also sonic technology. In addition (not represented) it is necessary to detect the current of the RF coil for purposes of operating the first EMUS transducer SIE, and also its eddy current impedance, and to account for the evaluation of the measured signals.

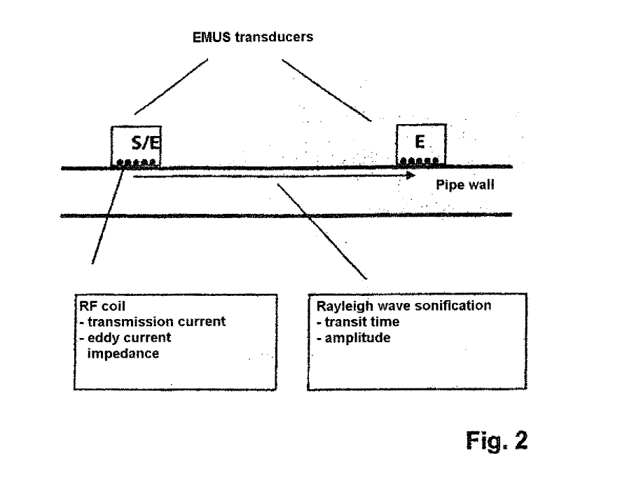

In the same manner it is possible to provide a sensor arrangement in accordance with the invention on the outer wall of a pipe for purposes of testing the pipe wall. Such an arrangement is represented in FIG. 2, which represent a partial longitudinal section through a pipe wall, on whose outer wall is placed the first EMUS transducer S/E and also, the second EMUS transducer E spaced axially apart along the pipe profile. Once again it is necessary, along with the measured ultrasound quantities, that is the echo amplitude and also the transit time at the location of the first EMUS transducer, to measure and store the eddy current data, that is the transmission current of the RF coil of the first EMUS transducer, as well as its eddy current impedance. By means of the EMUS transducer E, as in the above case, sound emission signals can be received and then evaluated. All the above measured data are compared with corresponding reference data, in order to register possible changes in the microstructure in the pipe wall.

In particular, as a result of additionally measuring and accounting for the transmission current and also the eddy current impedance of the RF coil of the first EMUS transducer, it is possible in a sensitive manner to detect microstructural changes even as they originate, that is in their initial phase.

1-15. (canceled)

16. A method for non-destructive material testing of a workpiece comprising an electrically conductive material using EMUS transducers each including a magnet unit for locally introducing a magnetic field into the workpiece and a radio frequency coil which interacts with the magnetic field, comprising:
at least two EMUS transducers spaced apart along a surface of the workpiece with at least a first EMUS transducer generating and detecting ultrasound waves within the workpiece and a second EMUS transducer at least detects ultrasound waves comprising:
a) detecting ultrasound echo signals which emanate from the first EMUS transducer with the first EMUS transducers;
b) detecting time resolvable ultrasound signals which are generated by the first EMUS transducer with the second EMUS transducer;
c) measuring transmission current of the radio frequency coil of the first EMUS transducer; and.
d) detecting an amplitude of a sound signal which originates from a flaw developing within the workpiece by a transducer of one of the EMUS transducers; and wherein
e) detecting non-destructively microstructural changes in the workpiece from results steps a) to d).

17. The method in accordance with claim 16, wherein:
in e) voltage across the RF coil of the first EMUS transducer is detected which is used in the early detection of microstructural changes.

18. The method in accordance with claim 17, wherein:
an eddy current impedance of the RF coil is measured while a transmission current of the RF coil is controlled.

19. The method in accordance with claim 16, wherein:
the first EMUS transducer generates ultrasound waves which propagate into the workpiece and ultrasound waves which propagate along the workpiece surface and components of the ultrasound waves are reflected as echo amplitudes within the workpiece in time-dependent form which are detected by the first EMUS transducer; and wherein
components of ultrasound waves propagating along the workpiece surface are detected by the second EMUS transducer.

20. The method in accordance with claim 17, wherein:
the first EMUS transducer generates ultrasound waves which propagate into the workpiece and the ultrasound waves which propagate along the workpiece surface and components of ultrasound waves are reflected as echo amplitudes within the workpiece in time-dependent form which are detected by the first EMUS transducer; and wherein
components of ultrasound waves propagating along the workpiece surface are detected by the second EMUS transducer.

21. The method in accordance with claim 18, wherein:
the first EMUS transducer generates ultrasound waves which propagate into the workpiece and ultrasound waves which propagate along the workpiece surface and components of the ultrasound waves are reflected as echo amplitudes within the workpiece in time-dependent form which are detected by the first EMUS transducer; and wherein
components of ultrasound waves propagating along the workpiece surface are detected by the second EMUS transducer.

22. The method in accordance with claim 16, wherein:
determining and using amplitude of ultrasound wave echo signals, amplitude of integrals of the ultrasound echo signals and transit times of the sonic signals for the non-destructive testing of the workpiece.

23. The method in accordance with claim 17, wherein:
the amplitude of ultrasound wave echo signals, amplitude of integrals of the ultrasound echo signals and transit times of the sonic signals are determined and used for the non-destructive testing of the workpiece.

24. The method in accordance with claim 18, wherein:
the amplitude of ultrasound wave echo signals, amplitude of integrals of the ultrasound echo signals and transit times of the sonic signals are determined and used for the non-destructive testing of the workpiece.

25. The method in accordance with claim 19, wherein:
the amplitude of ultrasound wave echo signals, amplitude of integrals of the ultrasound echo signals and transit times of the sonic signals are determined and used for the non-destructive testing of the workpiece.

26. The method in accordance with claim 20, wherein:
the amplitude of ultrasound wave echo signals, amplitude of integrals of the ultrasound echo signals and transit times of the sonic signals are determined and used for the non-destructive testing of the workpiece.

27. The method in accordance with claim 21, wherein:
the amplitude of ultrasound wave echo signals, amplitude of integrals of the ultrasound echo signals and transit times of the sonic signals are determined and used for the non-destructive testing of the workpiece.

28. The method in accordance with claim 16, comprising:
acquiring reference data regarding thermal fatigue of the workpiece relative to steps a) to d; and
generating reference data calibration curves obtained from the reference data relative to the workpiece and assessing results from steps a) to d) to detect microstructural changes.

29. The method in accordance with claim 17, comprising:
acquiring reference data regarding thermal fatigue of the workpiece relative to steps a) to d; and
generating reference data calibration curves obtained from the reference data relative to the workpiece and assessing results from steps a) to d) to detect microstructural changes.

30. The method in accordance with claim 18, comprising:
acquiring reference data regarding thermal fatigue of the workpiece relative to steps a) to d; and
generating reference data calibration curves obtained from the reference data relative to the workpiece and assessing results from steps a) to d) to detect microstructural changes.

31. The method in accordance with claim 19, comprising:
acquiring reference data regarding thermal fatigue of the workpiece relative to steps a) to d; and
generating reference data calibration curves obtained from the reference data relative to the workpiece and assessing results from steps a) to d) to detect microstructural changes.

32. The method in accordance with claim 22, comprising:
acquiring reference data regarding thermal fatigue of the workpiece relative to steps a) to d; and
generating reference data calibration curves obtained from the reference data relative to the workpiece and assessing results from steps a) to d) to detect microstructural changes.

33. The method in accordance with claim 16, comprising:
acquiring reference data regarding thermal fatigue of the workpiece relative to steps a) to d); and
generating reference data calibration curves obtained from the reference data relative to the workpiece and assessing results from steps a) to d) to detect microstructural changes.

34. The method in accordance with claim 17, wherein:
acquiring reference data regarding thermal fatigue of the workpiece relative to steps a) to d); and
generating reference data calibration curves obtained from the reference data relative to the workpiece and assessing results from steps a) to d) to detect microstructural changes.

35. The method in accordance with claim 18, wherein:
acquiring reference data regarding thermal fatigue of the workpiece relative to steps a) to d); and
generating reference data calibration curves obtained from the reference data relative to the workpiece and assessing results from steps a) to d) to detect microstructural changes.

36. The method in accordance with claim 19, wherein:
acquiring reference data regarding thermal fatigue of the workpiece relative to steps a) to d); and
generating reference data calibration curves obtained from the reference data relative to the workpiece and assessing results from steps a) to d) to detect microstructural changes.

37. The method in accordance with claim 22, wherein:
acquiring reference data regarding thermal fatigue of the workpiece relative to steps a) to d); and
generating reference data calibration curves obtained from the reference data relative to the workpiece and assessing results from steps a) to d) to detect microstructural changes.

38. The method in accordance with claim 28, wherein:
acquiring reference data regarding thermal fatigue of the workpiece relative to steps a) to d); and
generating reference data calibration curves obtained from the reference data relative to the workpiece and assessing results from steps a) to d) to detect microstructural changes.

39. The method in accordance with claim 16, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

40. The method in accordance with claim 17, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

41. The method in accordance with claim 18, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

42. The method in accordance with claim 19, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

43. The method in accordance with claim 22, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

44. The method in accordance with claim 28, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

45. The method in accordance with claim 33, wherein:
detecting sound emission signals originating from at least one flaw developing within the workpiece with the second EMUS transducer during a test cycle in which the second EMUS transducer is passively operated with a settable trigger threshold, and transient ultrasound signals are recorded.

46. The method in accordance with claim 16, wherein:
the first and second EMUS transducers are spaced apart on a surface of the workpiece to provide assignable reception apertures which are aligned parallel to one another in an identical reception direction.

47. The method in accordance with claim 17, wherein:
the first and second EMUS transducers are spaced apart on a surface of the workpiece to provide assignable reception apertures which are aligned parallel to one another in an identical reception direction.

48. The method in accordance with claim 18, wherein:
the first and second EMUS transducers are spaced apart on a surface of the workpiece to provide assignable reception apertures which are aligned parallel to one another in an identical reception direction.

49. The method in accordance with claim 19, wherein:
the first and second EMUS transducers are spaced apart on a surface of the workpiece to provide assignable reception apertures which are aligned parallel to one another in an identical reception direction.

50. The method in accordance with claim 22, wherein:
the first and second EMUS transducers are spaced apart on a surface of the workpiece to provide assignable reception apertures which are aligned parallel to one another in an identical reception direction.

51. The method in accordance with claim 28, wherein:
the first and second EMUS transducers are spaced apart on a surface of the workpiece to provide assignable reception apertures which are aligned parallel to one another in an identical reception direction.

52. The method in accordance with claim 33, wherein:
the first and second EMUS transducers are spaced apart on a surface of the workpiece to provide assignable reception apertures which are aligned parallel to one another in an identical reception direction.

53. The method in accordance with claim 38, wherein:
the first and second EMUS transducers are spaced apart on a surface of the workpiece to provide assignable reception apertures which are aligned parallel to one another in an identical reception direction.

54. The method in accordance with claim 16, wherein:
the second EMUS transducer functions as a reception transducer and provides signals regarding location of a microstructural flaw within the workpiece.

55. The method in accordance with claim 16, comprising:
using a voltage measured from reception by first and/or second EMUS transducer for the non-destructive testing.

56. The method in accordance with claim 16, wherein:
the first and second EMUS transducers are located on opposing surfaces or end faces of the workpiece, to provide reception apertures for each EMUS transducer which face towards one another to provide reception directions facing towards one another.

57. The method in accordance with claim 38, wherein:
the first and second EMUS transducers are located on opposing surfaces or end faces of the workpiece, to provide reception apertures for each EMUS transducer which face towards one another to provide reception directions facing towards one another.

58. The method in accordance with claim 16, wherein:
the workpiece which is being fatigue tested is a cylinder with a central region of a diameter less than ends of the workpiece.

59. A device for non-destructive material testing of a workpiece of an electrically conductive material with at least two spaced apart EMUS transducers each including a magnet unit for locally introducing a magnetic field into the workpiece and a radio frequency coil which interacts with the magnetic field which are spaced apart from each other along the workpiece comprising:
at least one EMUS transducer generating and detecting ultrasound waves within the workpiece and another EMUS transducer detecting at least ultrasound waves;
a control and evaluation unit which applies transmission current to the radio frequency coil of the at least one EMUS transducer, records an amplitude of the transmission current and eddy current impedance of the radio frequency coil of the at least one EMUS transducer, evaluates ultrasound echo signals received by the at least one EMUS transducer, integrates the amplitudes of the ultrasound signals received by the another EMUS transducer and measures transit time.

60. The device in accordance with claim 59, wherein:
the control and evaluation unit operates in a measuring mode in which the another EMUS transducer is passively operated with a settable trigger threshold, and transient signals from sound emissions are detected and recorded.
